(19) United States
(12) Patent Application Publication
(10) Pub. No.: US 2017/0180973 A1
(43) Pub. Date: Jun. 22, 2017

(54) COMMUNICATION DEVICE AND INFORMATION ACQUISITION SYSTEM

(71) Applicant: FUJITSU LIMITED, Kawasaki-shi (JP)

(72) Inventors: Koji Nakamichi, Yokohama (JP); Yohei Seki, Kawasaki (JP); Naoki Hasegawa, Kawasaki (JP); Yoshiaki Kawakatsu, Fukuoka (JP)

(73) Assignee: FUJITSU LIMITED, Kawasaki-shi (JP)

(21) Appl. No.: 15/361,876

(22) Filed: Nov. 28, 2016

(30) Foreign Application Priority Data
Dec. 16, 2015 (JP) 2015-245556

(51) Int. Cl. H04W 8/00; H04W 76/02

(52) U.S. Cl. CPC H04W 8/005; H04W 76/02; H04W 84/12

(57) ABSTRACT

A communication device includes a memory and a processor coupled to the memory. The processor is configured to transmit a first request to discover devices through radio communication. The processor is configured to discover first devices on basis of first responses to the first request within a predetermined period. The first responses are received from the respective first devices. The processor is configured to establish, after a lapse of the predetermined period, a connection with the respective first devices. The processor is configured to acquire information from the respective first devices.

### CROSS-REFERENCE TO RELATED APPLICATION

This application is based upon and claims the benefit of priority of the prior Japanese Patent Application No. 2015-245556, filed on Dec. 16, 2015, the entire contents of which are incorporated herein by reference.

### FIELD

The embodiments discussed herein are related to a communication device and an information acquisition system.

### BACKGROUND

In recent years, portable terminals such as smartphones, tablets, and the like, and communication devices included in household electric appliances such as televisions, digital cameras, and the like, are equipped with a near-field radio communication function. The near-field radio communication function may include, for example, a Bluetooth® communication function and a Wi-Fi Direct function.

For example, in a distribution system using the WiFi Direct function, there are some cases where an acquisition terminal such as a portable terminal acquires information by sequentially connecting with a plurality of circumjacent distribution terminals within a near-field radio communication range. The WiFi Direct function may include a device discovery function to discover a device equipped with the WiFi Direct function within the near-field radio communication range and a service discovery function to discover service information offered by the discovered device, in addition to functions of radio communication and information transmission between terminals.

The acquisition terminal discovers a distribution terminal by using the device discovery function through the near-field radio communication, and then, establishes a communicable connection with the discovered distribution terminal. Then, from the distribution terminal connected in communication, the acquisition terminal may acquire information retained in the distribution terminal.

A related technique is disclosed in, for example, Japanese Laid-Open Patent Publication No. 2005-085110.

There is a case where a plurality of distribution terminals exists within a radio communication range, and thus, a sequence of a device discovery process of discovering a distribution terminal and a connection establishment process of establishing a communicable connection with the discovered distribution terminal may be performed for two or more distribution terminals consecutively in the acquisition terminal. In this case, during the connection establishment process for a first discovered distribution terminal, the device discovery process of second and subsequent distribution terminals may be performed in parallel with the connection establishment process for the first discovered distribution terminal in the acquisition terminal, and the processes compete with each other. As a result, since the acquisition terminal is difficult to establish a communicable connection with the distribution terminals due to the competition between the device discovery process and the connection establishment process, it takes a time to acquire information, for example, icon information, from the distribution terminals within the near-field radio communication range. Therefore, it takes a time for a user of the acquisition terminal to display the icon information acquired from the respective distribution terminals.

### SUMMARY

According to an aspect of the present invention, provided is a communication device including a memory and a processor coupled to the memory. The processor is configured to transmit a first request to discover devices through radio communication. The processor is configured to discover first devices on basis of first responses to the first request within a predetermined period. The first responses are received from the respective first devices. The processor is configured to establish, after a lapse of the predetermined period, a connection with the respective first devices. The processor is configured to acquire information from the respective first devices.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a distribution system according to a first embodiment;

FIG. 2 is a diagram illustrating an exemplary hardware configuration of an acquisition terminal according to the first embodiment;

FIG. 3 is a diagram illustrating an exemplary functional configuration of a RAM and a CPU of the acquisition terminal according to the first embodiment;

FIG. 4 is a diagram illustrating an example of a discovered-terminal storage area according to the first embodiment;

FIG. 5 is a flowchart illustrating exemplary processing operations in a first connection process performed by the CPU of the acquisition terminal according to the first embodiment;

FIG. 6 is a diagram illustrating an exemplary distribution system according to a second embodiment;

FIG. 7 is a diagram illustrating an exemplary functional configuration of a RAM and a CPU of an acquisition terminal according to the second embodiment;

FIG. 8 is a diagram illustrating an example of a discovered-terminal storage area according to the second embodiment;

FIG. 9 is a diagram illustrating an exemplary format configuration of a service discovery response according to the second embodiment;

FIG. 10 is a flowchart illustrating exemplary processing operations in a second connection process performed by the CPU of the acquisition terminal according to the second embodiment;

FIG. 11 is a diagram illustrating an exemplary functional configuration of a distribution terminal according to a third embodiment;

FIG. 12 is a diagram illustrating an exemplary functional configuration of a RAM and a CPU of an acquisition terminal according to the third embodiment;

FIG. 13 is a flowchart illustrating exemplary processing operations in a circumjacent-terminal list registration process performed by the CPU of the distribution terminal according to the third embodiment;

FIG. 14 is a flowchart illustrating exemplary processing operations in a transmission process performed by the CPU of the distribution terminal according to the third embodiment; and

FIG. 15 is a flowchart illustrating exemplary processing operations in a third connection process performed by the CPU of the acquisition terminal according to the second embodiment.

### DESCRIPTION OF EMBODIMENTS

Hereinafter, embodiments of a communication device and an information acquisition system of the present disclosure will be described with reference to the accompanying drawings.

### First Embodiment

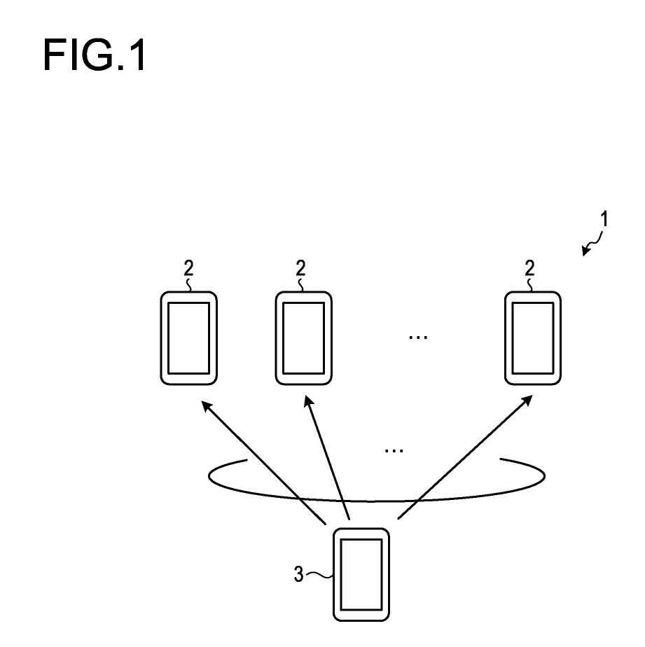

FIG. 1 is a diagram illustrating an example of a distribution system 1 according to a first embodiment. As illustrated in FIG. 1, the distribution system 1 includes a plurality of distribution terminals 2 and an acquisition terminal 3. Each of the distribution terminals 2 is a terminal that distributes stored contents to a circumjacent acquisition terminal 3. The acquisition terminal 3 is a terminal that receives the contents distributed from the distribution terminals 2 and displays the received contents.

The distribution terminals 2 and the acquisition terminal 3 have a near-field radio communication function such as a WiFi Direct function. The acquisition terminal 3 is, for example, a portable terminal such as a smartphone or a tablet. The distribution terminals 2 distribute service information, such as contents, to the acquisition terminal 3 existing within a near-field radio communication range through near-field radio communication. The WiFi Direct function includes a device discovery function to discover a device equipped with the WiFi Direct function, which exists within the near-field radio communication range, in addition to a function of radio connection or information transmission between the distribution terminal 2 and the acquisition terminal 3, between the distribution terminals 2, or between the acquisition terminals 3. In addition, the WiFi Direct function includes a service discovery function to discover service information provided by a device equipped with the WiFi Direct function. The acquisition terminal 3 discovers a distribution terminal 2 by using the device discovery function or the like, and acquires contents from the discovered distribution terminal 2. The contents are information contents such as display icons of advertisement distribution, use guidance within a facility, sales information, or the like. A user of the acquisition terminal 3 who enters a facility discovers a distribution terminal 2 existing within the near-field radio communication range, acquires contents from the discovered distribution terminal 2, and browses the acquired contents.

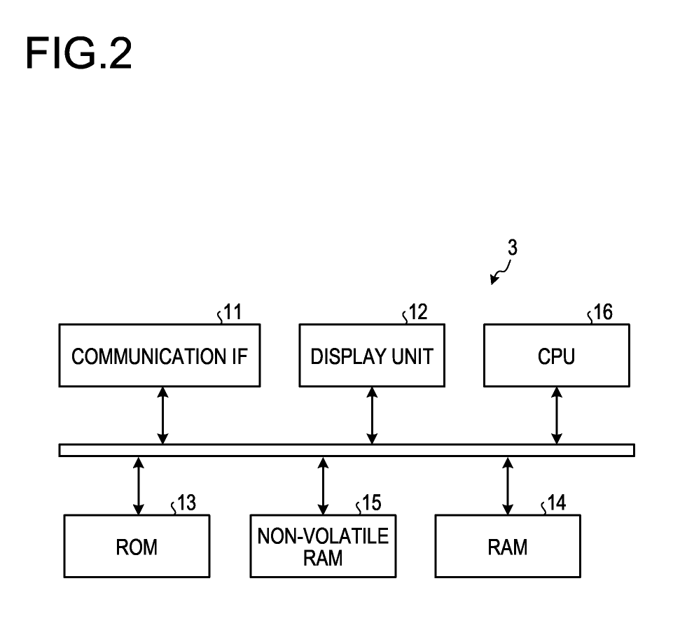

FIG. 2 is a diagram illustrating an exemplary hardware configuration of the acquisition terminal 3. As illustrated in FIG. 2, the acquisition terminal 3 includes a communication interface (hereinafter, referred to as a communication IF) 11, a display unit 12, a read-only memory (ROM) 13, a random access memory (RAM) 14, a non-volatile RAM 15, and a central processing unit (CPU) 16. The communication IF 11 is an interface responsible for communication such as typical radio communication or near-field radio communication. The display unit 12 is an output interface which displays a variety of information such as contents, icons and lists. The ROM 13 is an area for storing a variety of information such as programs. The RAM 14 is a work area used by, for example, the CPU 16. The non-volatile RAM 15 is an area for storing a variety of information such as downloaded programs. The CPU 16 controls the entire acquisition terminal 3. The CPU 16 loads a program stored in the ROM 13 into the RAM 14 and performs a processing function with the program loaded into the RAM 14 as a process.

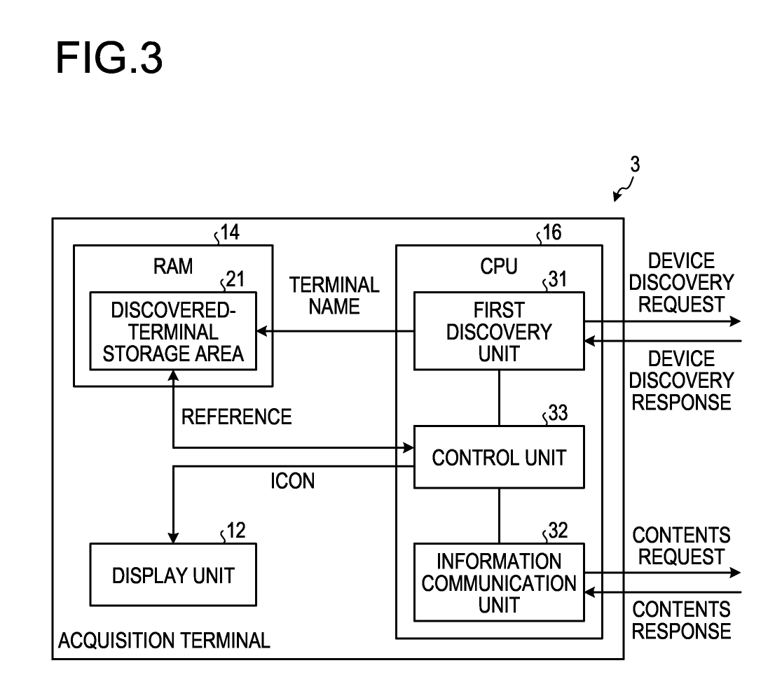

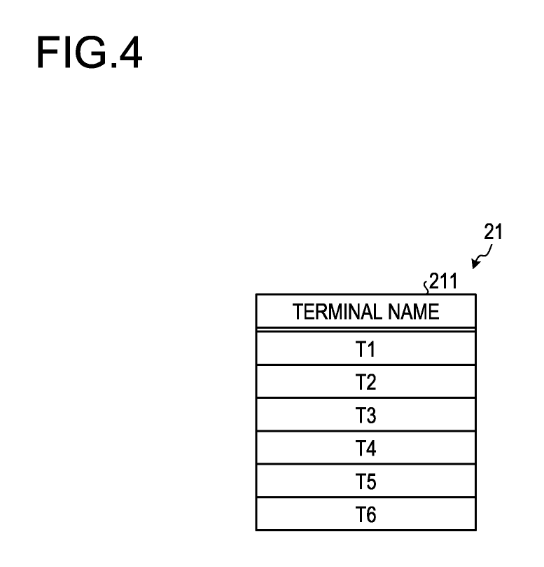

FIG. 3 is a diagram illustrating an exemplary functional configuration of the RAM 14 and the CPU 16 of the acquisition terminal 3. As illustrated in FIG. 3, the RAM 14 includes a discovered-terminal storage area 21. FIG. 4 is a diagram illustrating an example of the discovered-terminal storage area 21. The discovered-terminal storage area 21 illustrated in FIG. 4 stores a list of terminal names 211, which identify the distribution terminals 2 discovered by the acquisition terminal 3 itself by using the device discovery function, as a discovered-terminal list. The acquisition terminal 3 may identify the distribution terminals 2 capable of offering a service by referring to the terminal names 211 registered in the discovered-terminal storage area 21. It is assumed that the terminal names of the distribution terminals 2 are preset so as to identify the distribution terminals 2.

The CPU 16 includes a first discovery unit 31, an information communication unit 32, and a control unit 33. The first discovery unit 31 is responsible for the device discovery function. The first discovery unit 31 distributes a device discovery request in a broadcasting manner through the near-field radio communication via the communication IF 11. Upon distributing the device discovery request, the first discovery unit 31 starts a timer for a predetermined search period. The predetermined search period is a minimum period set so as to prevent a user of the acquisition terminal 3 from feeling uncomfortable until the user displays, on an application, all icons acquired in response to the device discovery request within a near-field radio communication range. The predetermined search period is also a period during which distribution terminals 2 responding to the device discovery request are searched for. The first discovery unit 31 receives a device discovery response to the device discovery request within the search period via the communication IF 11. In response to the device discovery request received from the acquisition terminal 3, the distribution terminal 2 returns a device discovery response containing its own terminal name to the acquisition terminal 3. Upon receiving the device discovery response, the first discovery unit 31 extracts the terminal name contained in the device discovery response and registers the extracted terminal name as a terminal name 211 in the discovered-terminal storage area 21. When the search period elapses, the first discovery unit 31 ends the operations (device discovery operations) of monitoring the device discovery response in response to the device discovery request.

The information communication unit 32 is a communication unit that transmits a contents request to the distribution terminals 2 via the communication IF 11. The information communication unit 32 receives a contents response to the contents request from the respective distribution terminals 2 via the communication IF 11. In response to the contents request received from the acquisition terminal 3, the distribution terminal 2 returns a contents response containing contents to the acquisition terminal 3.

The control unit 33 controls the entire CPU 16. The control unit 33 requests the first discovery unit 31 to perform the device discovery process between the control unit 33 and a device within the near-field radio communication range. The control unit 33 refers to the terminal names 211 registered in the discovered-terminal storage area 21 and requests the information communication unit 32 to perform a connection establishment process for the respective distribution terminals 2 corresponding to the terminal names 211. Upon receiving the contents response from a distribution terminal 2 via the information communication unit 32, the control unit 33 acquires the contents (for example, an icon) contained in the contents response. Then, on the application, the control unit 33 displays the acquired icon on the display unit 12. That is, the control unit 33 displays all icons on the display unit 12. When an icon displayed on the display unit 12 is designated, the control unit 33 requests a distribution terminal 2 to provide contents for the designated icon and acquires the contents from the distribution terminal 2.

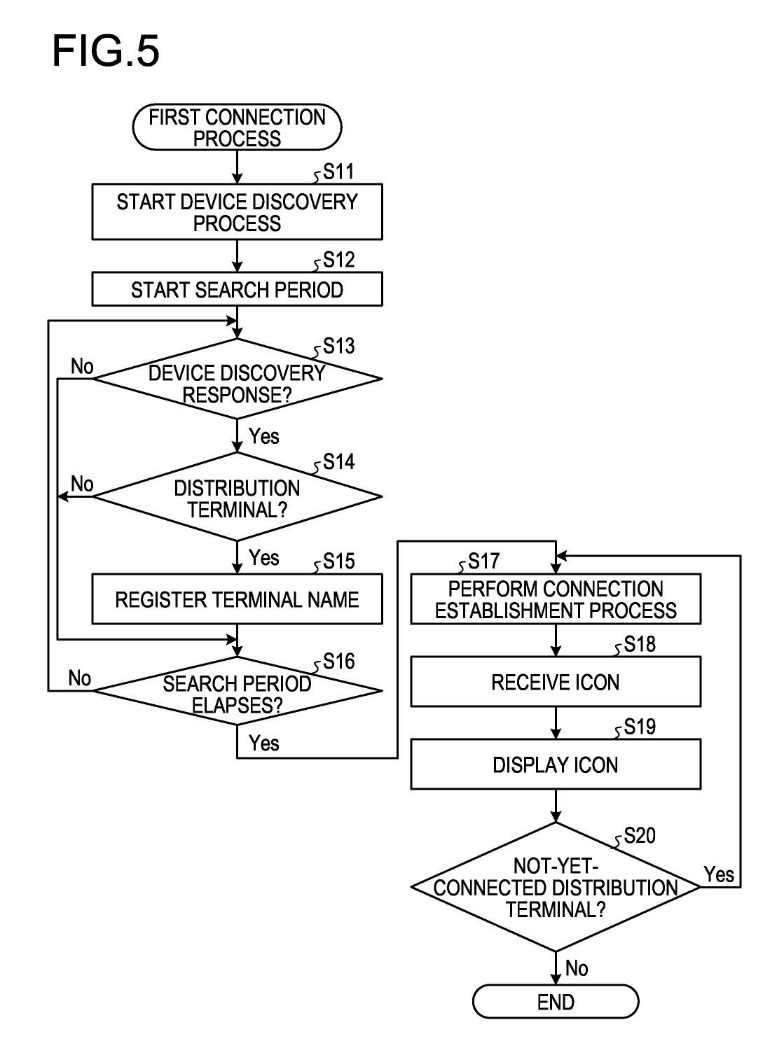

Next, the operations of the distribution system 1 according to the first embodiment will be described. FIG. 5 is a flowchart illustrating exemplary processing operations in a first connection process performed by the CPU 16 of the acquisition terminal 3. The first connection process is a process of registering terminal names of distribution terminals 2, which are discovered through the device discovery process within a search period, in a discovered-terminal list, and establishing, after a lapse of the search period, communicable connections with the distribution terminals 2 discovered through the device discovery process by referring to the discovered-terminal list.

In FIG. 5, the first discovery unit 31 of the CPU 16 starts the execution of the device discovery process to distribute a device discovery request in a broadcasting manner (S11). The first discovery unit 31 starts a timer for the search period in response to starting the execution of the device discovery process (S12).

The first discovery unit 31 determines whether or not a device discovery response to the device discovery request of the device discovery process is received (S13). When it is determined that a device discovery response is received (Yes in S13), the first discovery unit 31 determines whether or not a discovered device is a distribution terminal 2 (S14). When it is determined that the discovered device is a distribution terminal 2 (Yes in S14), the first discovery unit 31 extracts a terminal name of a distribution terminal 2 from the device discovery response and adds the extracted terminal name to the discovered-terminal list to register the extracted terminal name in the discovered-terminal storage area 21 (S15).

After registering the terminal name in the discovered-terminal storage area 21, the first discovery unit 31 determines whether or not the search period started at S12 elapses (S16). When it is determined that the search period elapses (Yes in S16), the control unit 33 of the CPU 16 requests the information communication unit 32 to perform a connection establishment process for a distribution terminal 2 registered in the discovered-terminal storage area 21 (S17).

The control unit 33 receives an icon from the connected distribution terminal 2 via the information communication unit 32 (S18), and displays the received icon on an application (S19). The control unit 33 determines whether or not a distribution terminal 2 which is not yet connected is registered in the discovered-terminal storage area 21 (S20). When it is determined that a distribution terminal 2 which is not yet connected is registered in the discovered-terminal storage area 21 (Yes in S20), the control unit 33 proceeds to S17 in order to request the information communication unit 32 to perform the connection establishment process for a not-yet-connected distribution terminal 2.

When it is determined that no distribution terminal 2 which is not yet connected is registered in the discovered-terminal storage area 21 (No in S20), the control unit 33 ends the processing operations illustrated in FIG. 5. When it is determined that a device discovery response is not received (No in S13) or when it is determined that the discovered device is not a distribution terminal 2 (No in S14), the first discovery unit 31 proceeds to S16 in order to determine whether or not the search period elapses. When it is determined that the search period does not elapse (No in S16), the first discovery unit 31 proceeds to S13 in order to determine whether or not a device discovery response is received.

Upon receiving the device discovery response to the device discovery request within the search period, the acquisition terminal 3 which performs the first connection process registers, in the discovered-terminal storage area 21, a terminal name of a distribution terminal 2 which is discovered through the device discovery process. After a lapse of the search period, the acquisition terminal 3 establishes a communicable connection with the respective discovered distribution terminals 2 by referring to the terminal names registered in the discovered-terminal storage area 21 and acquires icons from the respective distribution terminals 2. As a result, since the acquisition terminal 3 may avoid a competition of processing of the device discovery function and the connection establishment function between the acquisition terminal 3 and the distribution terminals 2, the acquisition terminal 3 may quickly acquire the icons from the distribution terminals 2. Then, a user of the acquisition terminal 3 may reduce time taken from acquisition to display of the icon of the distribution terminal 2.

The acquisition terminal 3 according to the first embodiment performs the device discovery function within the search period, sequentially establishes a communicable connection with distribution terminals 2 discovered by using the device discovery function after a lapse of the search period to acquire an icon from the connected distribution terminal 2. As a result, since the competition of processing of the device discovery function and the connection establishment function may be avoided, the icons may be quickly acquired from the distribution terminals 2, thereby reducing the time taken to display the icons.

The acquisition terminal 3 according to the first embodiment discovers distribution terminals 2 within the near-field radio communication range in the search period by using the device discovery function, and registers terminal names of the discovered distribution terminals 2 in the discovered-terminal storage area 21. However, the present disclosure is not limited thereto. Hereinafter, a second embodiment will be described.

### Second Embodiment

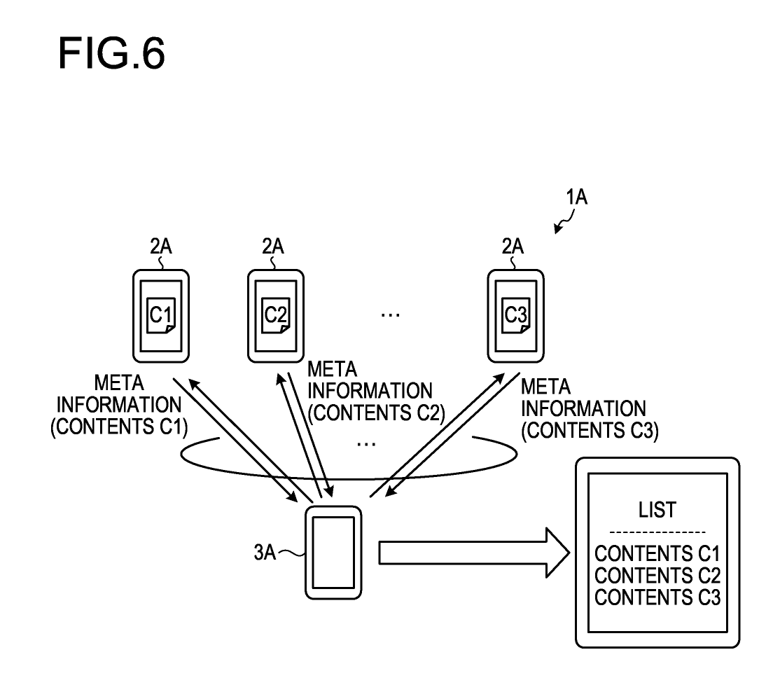

FIG. 6 is a diagram illustrating an example of a distribution system 1A according to the second embodiment. In FIG. 6, similar elements to those of the distribution system 1 will be denoted by similar reference numerals to those used for the distribution system 1, and thus, overlapping descriptions of the configurations and the operations thereof will be omitted.

The distribution system 1A according to the second embodiment is characterized in that, upon receiving a device discovery response from a distribution terminal 2A, and further receiving a service discovery response to a service discovery request from the discovered distribution terminal 2A, an acquisition terminal 3A acquires meta information including a contents name in addition to a terminal name. The meta information is, for example, related information identifying the distribution terminal 2A, related information identifying service contents distributed by the distribution terminal 2A, and the like. A service discovery process is an optional function of the device discovery process. Upon receiving a device discovery response from a distribution terminal 2A, the acquisition terminal 3A transmits a service discovery request to the distribution terminal 2A. Upon receiving the service discovery request, the distribution terminal 2A stores a contents name of contents managed by itself in a service discovery response and returns the service discovery response to the acquisition terminal 3A. Upon receiving the service discovery response from the distribution terminal 2A, the acquisition terminal 3A extracts the contents name contained in the service discovery response.

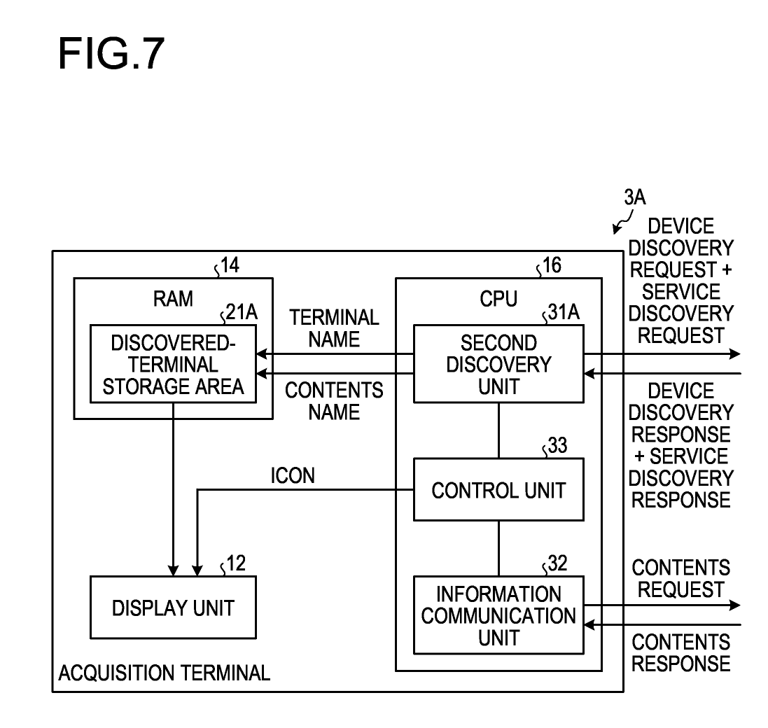

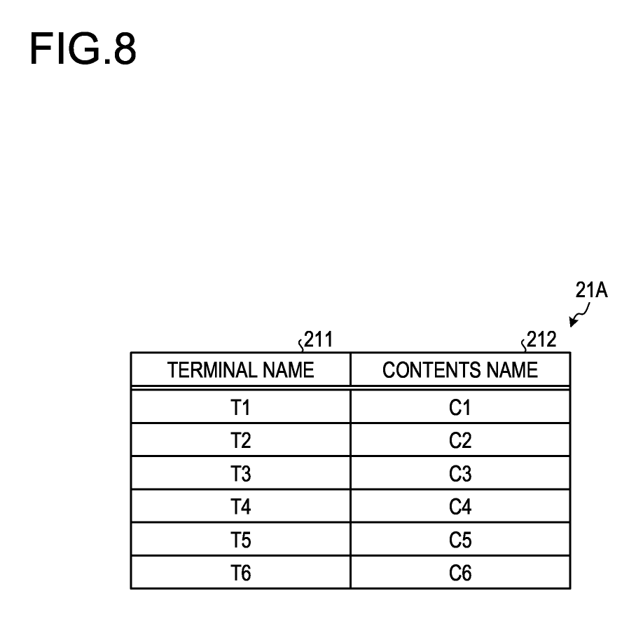

FIG. 7 is a diagram illustrating an exemplary functional configuration of a RAM 14 and a CPU 16 of the acquisition terminal 3A. FIG. 8 is a diagram illustrating an example of a discovered-terminal storage area 21A. The discovered-terminal storage area 21A illustrated in FIG. 8 stores a discovered-terminal list which associates terminal names 211 of respective discovered distribution terminals 2A and contents names 212 identifying contents stored in the respective distribution terminals 2A. The CPU 16 includes a second discovery unit 31A, in addition to the information communication unit 32 and the control unit 33. The second discovery unit 31A is responsible for the device discovery function and the service discovery function. The second discovery unit 31A distributes a device discovery request in a broadcasting manner through the near-field radio communication via the communication IF 11. The second discovery unit 31A receives a device discovery response to the device discovery request via the communication IF 11. The second discovery unit 31A transmits a service discovery request for the device discovered by using the device discovery function via the communication IF 11. In response to the received service discovery request, the distribution terminal 2A stores a contents name of contents managed by itself in a service discovery response and returns the service discovery response to the acquisition terminal 3A. The second discovery unit 31A receives the service discovery response to the service discovery request from the distribution terminal 2A. Upon receiving the service discovery response, the second discovery unit 31A extracts meta information such as a contents name contained in the service discovery response. Then, the second discovery unit 31A registers the extracted terminal name and contents name in the discovered-terminal storage area 21A.

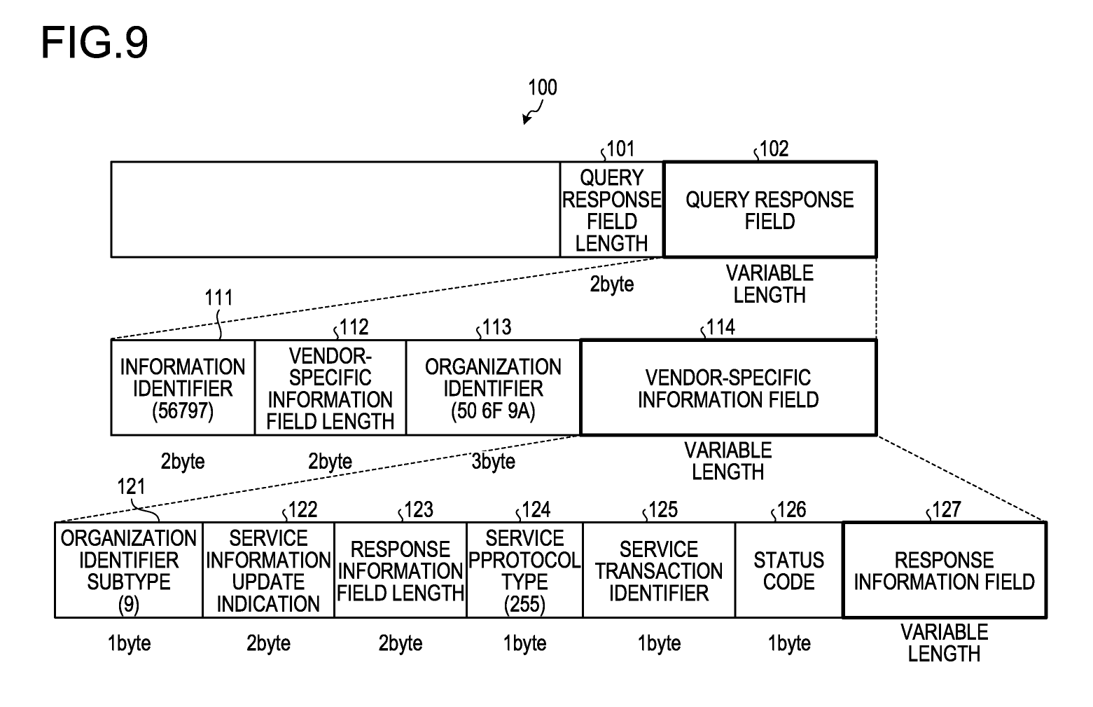

FIG. 9 is a diagram illustrating an exemplary format configuration of the service discovery response. The service discovery response is a generic advertisement service (GAS) initial response. A GAS initial response 100 includes a query response field length 101, a query response field 102, and the like. The GAS is a mechanism for advertising information through a wireless local area network (LAN), which is defined in IEEE802.11u. The GAS initial response 100 is a frame for responding to a GAS initial request such as the device discovery request.

The query response field 102 is, for example, a query response field of access network query protocol (ANQP) and stores information of a response to the service discovery request. The ANQP is a protocol for exchanging information on the GAS, which is defined in IEEE802.11u. The query response field 102 includes an information identifier 111, a vendor-specific information field length 112, an organization identifier 113, and a vendor-specific information field 114. The information identifier 111 includes a fixed value for use of the vendor-specific information field 114. The organization identifier 113 includes a fixed value indicating WiFi Alliance, which is a standardization of Wi-Fi Direct.

The vendor-specific information field 114 is a field for WiFi Alliance-specific service discovery response. The vendor-specific information field 114 includes an organization identifier subtype 121, a service information update indication 122, a response information field length 123, and a service protocol type 124. In addition, the vendor-specific information field 114 includes a service transaction identifier 125, a status code 126, and a response information field 127. The response information field 127 is an area for storing information to be responded in a service discovery response, for example, meta information such as a contents name. The service protocol type 124 is vendor-specific information.

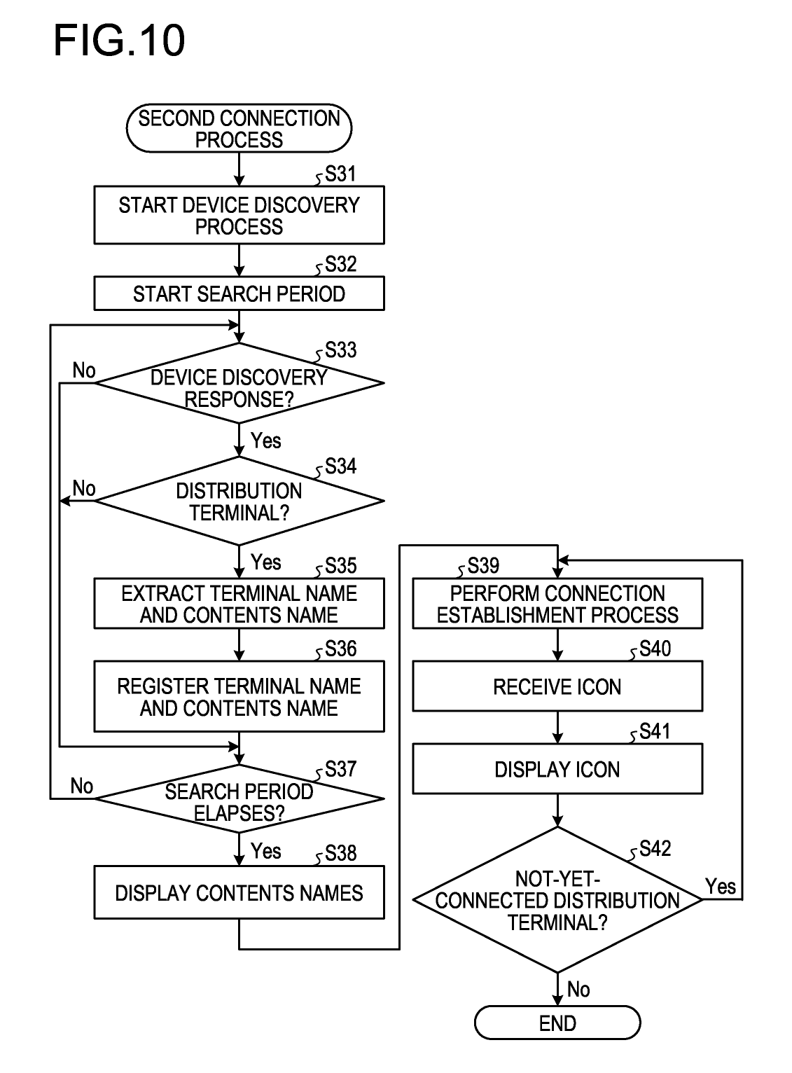

Next, the operations of the distribution system 1A according to the second embodiment will be described. FIG. 10 is a flowchart illustrating exemplary processing operations in a second connection process performed by the CPU 16. The second connection process illustrated in FIG. 10 is a process of registering terminal names and contents names of distribution terminals 2A, which are discovered through the device discovery process within a search period, in a discovered-terminal list, and establishing, after a lapse of the search period, communicable connection with the distribution terminal 2A by referring to the discovered-terminal list.

In FIG. 10, the second discovery unit 31A of the CPU 16 starts the execution of the device discovery process to distribute a device discovery request in a broadcasting manner (S31). The second discovery unit 31A starts a timer for the search period in response to starting the execution of the device discovery process (S32).

The second discovery unit 31A determines whether or not a device discovery response to the device discovery request of the device discovery process is received (S33). A terminal name of a device which receives the device discovery request is stored in the device discovery response. When it is determined that a device discovery response is received (Yes in S33), the second discovery unit 31A determines whether or not the discovered device is a distribution terminal 2A (S34). When it is determined that the discovered device is a distribution terminal 2A (Yes in S34), the second discovery unit 31A extracts a terminal name and a contents name of the distribution terminal 2A (S35). At this time, the acquisition terminal 3A transmits a service discovery request to the discovered distribution terminal 2A and extracts a contents name of the distribution terminal 2A in a service discovery response to the service discovery request upon receiving the service discovery response. The second discovery unit 31A adds the extracted terminal name and contents name of the distribution terminal 2A to the discovered-terminal list to register the extracted terminal name and contents name in the discovered-terminal storage area 21A (S36).

After adding the terminal name and contents name to the discovered-terminal list, the second discovery unit 31A determines whether or not the search period started at S32 elapses (S37). When it is determined that the search period elapses (Yes in S37), the second discovery unit 31A displays the contents names on the display unit 12 in a list format by referring to the discovered-terminal list (S38). As a result, a user of the acquisition terminal 3A may recognize the contents names of the distribution terminals 2A which are discovered through the device discovery process.

After displaying the contents name list, the control unit 33 of the CPU 16 refers to the discovered-terminal list and requests the information communication unit 32 to perform a connection establishment process for a distribution terminal 2A (S39). The control unit 33 receives an icon from the connected distribution terminal 2A via the information communication unit 32 (S40), and displays the received icon on an application (S41). The control unit 33 determines whether or not a distribution terminal 2A which is not yet connected exists within the discovered-terminal list (S42). When it is determined that a distribution terminal 2A which is not yet connected exists within the discovered-terminal list (Yes in S42), the control unit 33 proceeds to S39 in order to request the information communication unit 32 to perform the connection establishment process for a not-yet-connected distribution terminal 2.

When it is determined that no distribution terminal 2A which is not yet connected exists within the discovered-terminal list (No in S42), the control unit 33 ends the processing operations illustrated in FIG. 10. When it is determined that a device discovery response is not received (No in S33) or when it is determined that the discovered device is not a distribution terminal 2A (No in S34), the second discovery unit 31A proceeds to S37 in order to determine whether or not the search period elapses. When it is determined that the search period does not elapse (No in S37), the second discovery unit 31A proceeds to S33 in order to determine whether or not a device discovery response is received.

Upon receiving the device discovery response to the device discovery request within the search period, the acquisition terminal 3A which performs the second connection process registers, in the discovered-terminal list, a terminal name and a contents name of a distribution terminal 2A which is discovered through the device discovery process. In addition, the acquisition terminal 3A displays the contents names contained in the discovered-terminal list on the display unit 12 in a list format. As a result, a user of the acquisition terminal 3A may recognize contents which may be offered by circumjacent distribution terminals 2A, by referring to the content name list.

After a lapse of the search period, the acquisition terminal 3A establishes a communicable connection with the respective discovered distribution terminals 2A by referring to the discovered-terminal list to acquire an icon from the respective distribution terminals 2A. As a result, since the acquisition terminal 3A may avoid the competition between the device discovery process and the connection establishment process owing to the search period, the icons may be quickly acquired from the distribution terminals 2A. Further, a user of the acquisition terminal 3A may reduce time taken from the acquisition to the display of the icons of the distribution terminals 2A.

The acquisition terminal 3A according to the second embodiment discovers distribution terminals 2A within the search period by using the device discovery function and the service discovery function, and registers terminal names and contents names of the distribution terminals 2A in the discovered-terminal list. However, the present disclosure is not limited thereto. Hereinafter, a third embodiment will be described. In the third embodiment, similar elements to those of the distribution system 1 according to the first embodiment will be denoted by similar reference numerals to those used for the distribution system 1, and thus, overlapping descriptions of the configurations and the operations thereof will be omitted.

### Third Embodiment

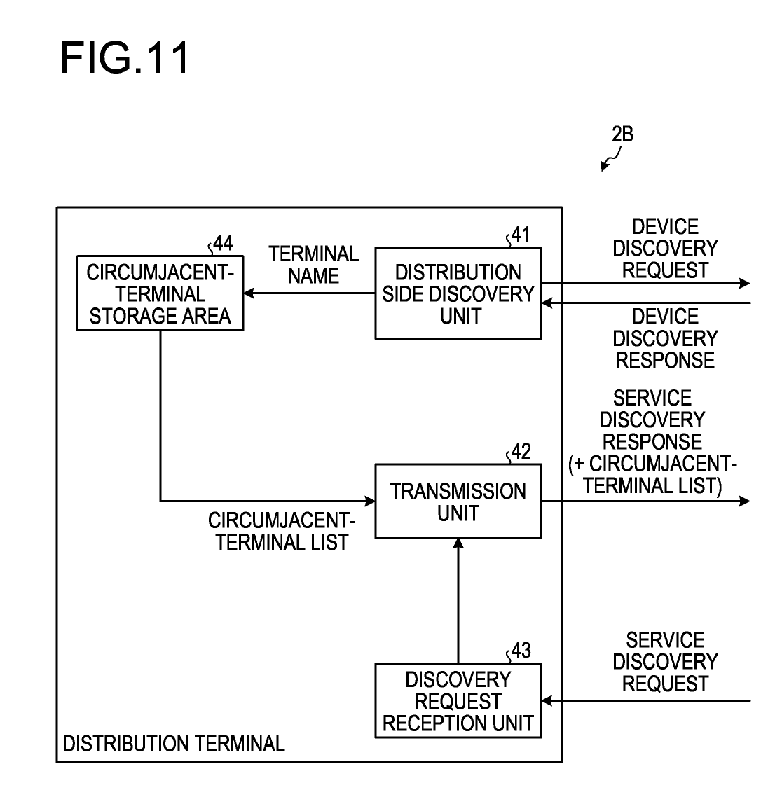

FIG. 11 is a diagram illustrating an exemplary functional configuration of a distribution terminal 2B according to the third embodiment. As illustrated in FIG. 11, the distribution terminal 2B includes a distribution side discovery unit 41, a transmission unit 42, a discovery request reception unit 43, and a circumjacent-terminal storage area 44. The distribution side discovery unit 41 distributes a device discovery request from the distribution terminal 2B itself to other distribution terminals 2B in a broadcasting manner through near-field radio communication and receives a device discovery response to the device discovery request from the respective other distribution terminals 2B. Upon receiving a device discovery response, the distribution side discovery unit 41 adds a terminal name of the distribution terminal 2B, which returns the device discovery response, to a circumjacent-terminal list to register the terminal name in the circumjacent-terminal storage area 44. The circumjacent-terminal list is a list of the other distribution terminals 2B discovered within a near-field radio communication range of the distribution terminal 2B.

The discovery request reception unit 43 receives a service discovery request from an acquisition terminal 3B. Upon receiving the service discovery request from the acquisition terminal 3B, the transmission unit 42 acquires the circumjacent-terminal list stored in the circumjacent-terminal storage area 44. The transmission unit 42 stores the circumjacent-terminal list in a service discovery response to the service discovery request received from the acquisition terminal 3B and transmits the service discovery response to the acquisition terminal 3B.

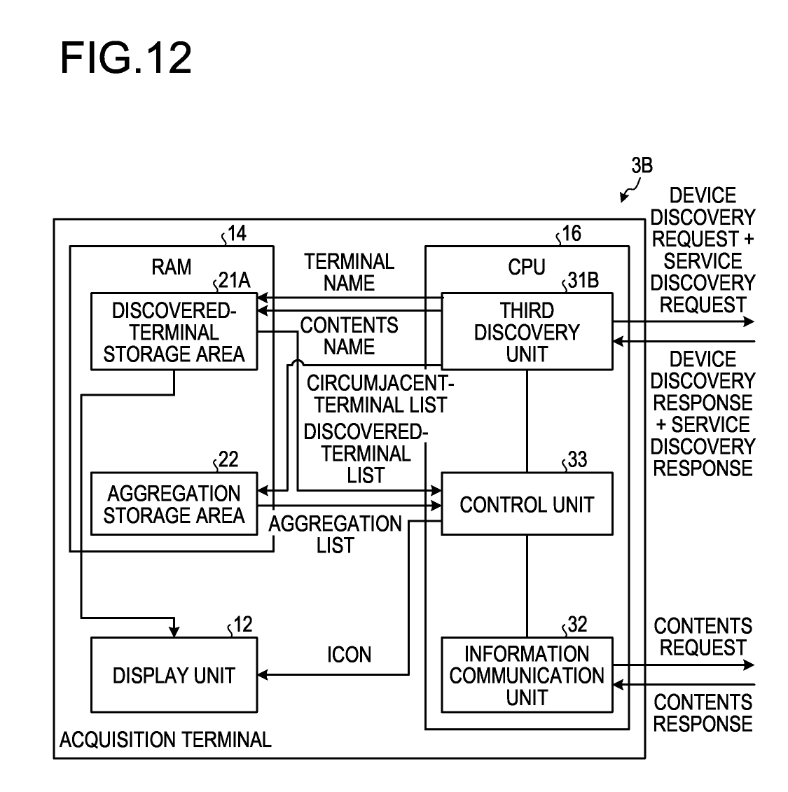

FIG. 12 is a diagram illustrating an exemplary functional configuration of a RAM 14 and a CPU 16 of the acquisition terminal 3B according to the third embodiment. The RAM 14 illustrated in FIG. 12 includes a discovered-terminal storage area 21A and an aggregation storage area 22. The discovered-terminal storage area 21A is an area for storing a discovered-terminal list associating terminal names 211 of distribution terminals 2B discovered by using the device discovery function and contents names 212 of contents managed by the respective distribution terminal 2B. The aggregation storage area 22 is an area for storing a circumjacent-terminal list contained in a device discovery response received from the distribution terminal 2B. The CPU 16 includes a third discovery unit 31B, in addition to the information communication unit 32 and the control unit 33.

The third discovery unit 31B is responsible for the device discovery function and the service discovery function. The third discovery unit 31B distributes a device discovery request and a service discovery request through the near-field radio communication via the communication IF 11. The third discovery unit 31B receives a device discovery response to the device discovery request via the communication IF 11 and receives a service discovery response to the service discovery request via the communication IF 11. In response to the device discovery request received from the acquisition terminal 3B, the distribution terminal 2B returns the device discovery response containing its own terminal name, to the acquisition terminal 3B. Upon receiving the device discovery response, the third discovery unit 31B extracts the terminal name contained in the device discovery response. Upon receiving the service discovery response, the third discovery unit 31B extracts meta information such as a contents name contained in the service discovery response. Then, the third discovery unit 31B registers the extracted terminal name and contents name in the discovered-terminal storage area 21A. Upon receiving the service discovery response, the third discovery unit 31B extracts the circumjacent-terminal list contained in the service discovery response. The third discovery unit 31B registers the extracted circumjacent-terminal list in the aggregation storage area 22. When a terminal name in the circumjacent-terminal list is already registered in the aggregation storage area 22, the third discovery unit 31B does not register the terminal name again. When a terminal name in the circumjacent-terminal list is not yet registered in the aggregation storage area 22, the third discovery unit 31B registers the terminal name in the aggregation storage area 22.

The control unit 33 refers to the circumjacent-terminal list (aggregation list) in the aggregation storage area 22 to request the third discovery unit 31B to issue the device discovery request for each distribution terminal 2B in the circumjacent-terminal list. The control unit 33 refers to the discovered-terminal list to request the information communication unit 32 to perform the connection establishment process for each distribution terminal 2B in the discovered-terminal list to issue a contents request.

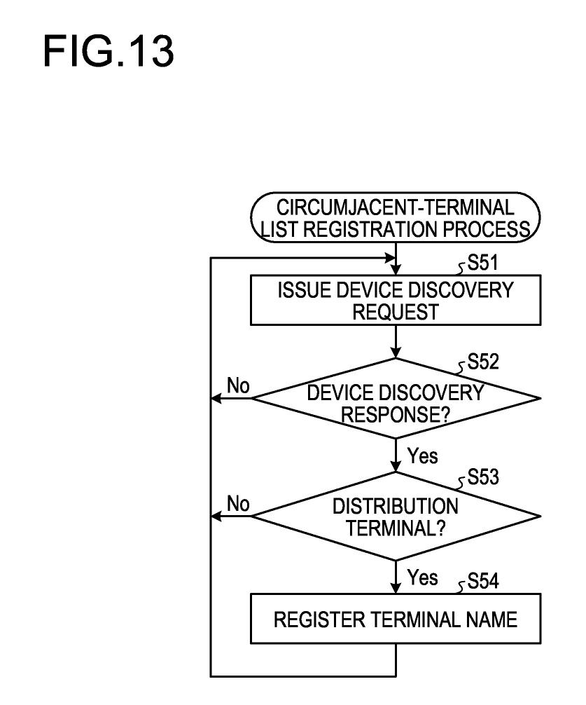

Next, the operations of a distribution system according to the third embodiment will be described. FIG. 13 is a flowchart illustrating exemplary processing operations in a circumjacent-terminal list registration process performed by the distribution terminal 2B. The circumjacent-terminal list registration process illustrated in FIG. 13 is a process of creating a circumjacent-terminal list of terminal names of circumjacent distribution terminals 2B around a particular distribution terminal 2B, and registering the circumjacent-terminal list in the circumjacent-terminal storage area 44. The distribution side discovery unit 41 in FIG. 13 transmits a device discovery request to circumjacent distribution terminals 2B (S51). The distribution side discovery unit 41 determines whether or not a device discovery response to the device discovery request is received (S52).

When it is determined that a device discovery response is received (Yes in S52), the distribution side discovery unit 41 determines whether or not the discovered device is a distribution terminal 2B, based on the device discovery response (S53). When it is determined that the discovered device is a distribution terminal 2B (Yes in S53), the distribution side discovery unit 41 adds a terminal name of the distribution terminal 2B to a circumjacent-terminal list to register the terminal name in the circumjacent-terminal storage area 44 (S54) and proceeds to S51 in order to perform the device discovery process.

When it is determined that a device discovery response is not received (No in S52) or when it is determined that the discovered device is not a distribution terminal 2B (No in S53), the distribution side discovery unit 41 proceeds to S51 in order to perform the device discovery process.

A distribution terminal 2B which performs the circumjacent-terminal list registration process discovers other distribution terminals 2B within the near-field radio communication range by using the device discovery function and registers the circumjacent-terminal list including terminal names of the discovered distribution terminals 2B in the circumjacent-terminal storage area 44. As a result, the distribution terminal 2B may recognize other distribution terminals 2B existing circumferentially by referring to the circumjacent-terminal list.

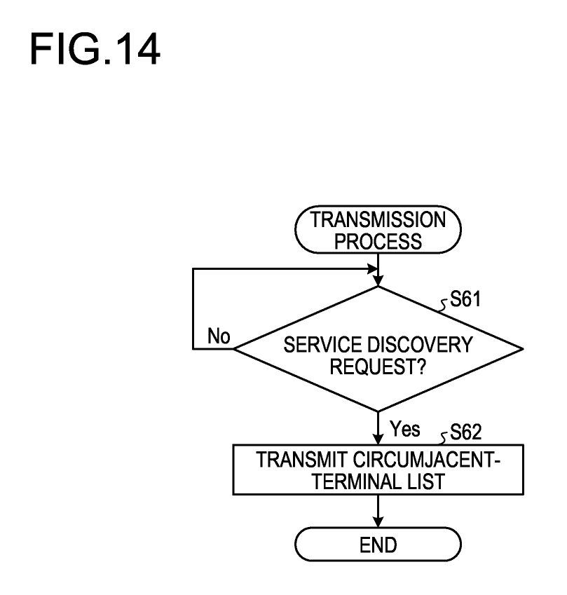

FIG. 14 is a flowchart illustrating exemplary processing operations in a transmission process performed by the distribution terminal 2B. The transmission process illustrated in FIG. 14 is a process of transmitting a circumjacent-terminal list from a distribution terminal 2B to the acquisition terminal 3B.

In FIG. 14, the discovery request reception unit 43 of the distribution terminal 2B determines whether or not a service discovery request is received from the acquisition terminal 3B (S61). When it is determined that a service discovery request is received (Yes in S61), the transmission unit 42 of the distribution terminal 2B stores the circumjacent-terminal list in a service discovery response to return the service discovery response to the acquisition terminal 3B (S62), and then, ends the processing operations illustrated in FIG. 14.

When it is determined that a service discovery request is not received (No in S61), the discovery request reception unit 43 proceeds to S61 in order to determine whether or not a service discovery request is received from the acquisition terminal 3B.

Upon receiving the service discovery request from the acquisition terminal 3B, the distribution terminal 2B stores the circumjacent-terminal list in the service discovery response and transmits the service discovery response to the acquisition terminal 3B. As a result, the distribution terminal 2B may transmit the circumjacent-terminal list to the acquisition terminal 3B by using the service discovery response.

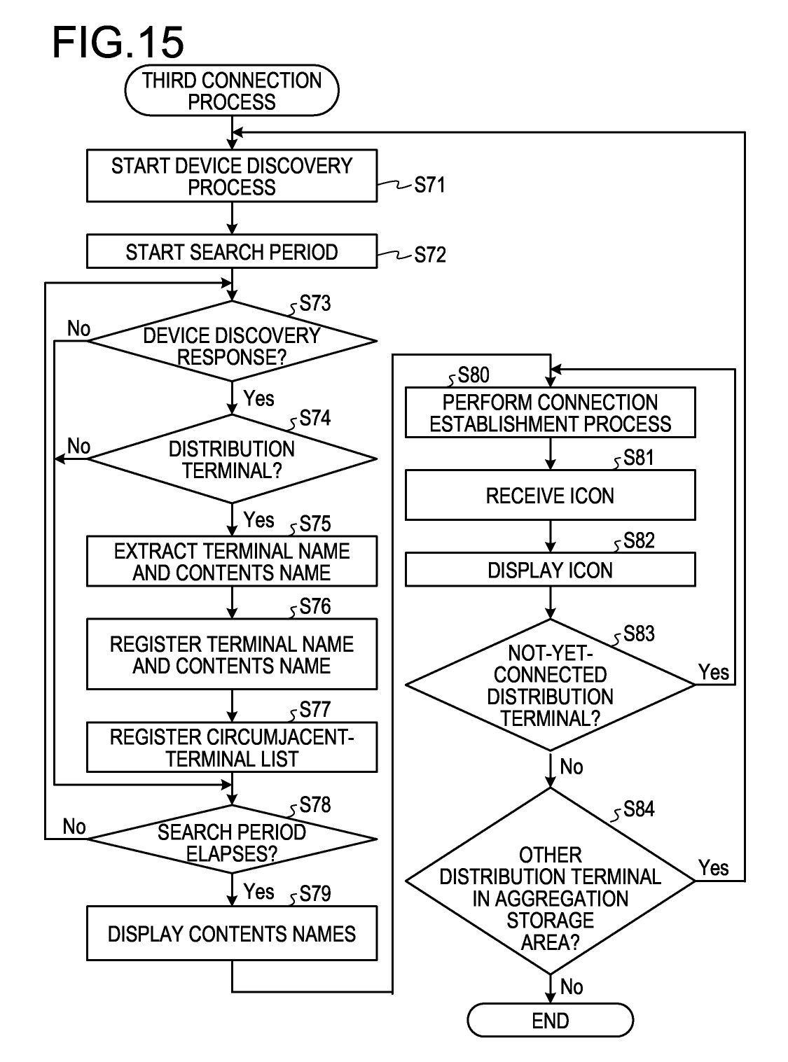

FIG. 15 is a flowchart illustrating exemplary processing operations in a third connection process performed by the CPU 16. The third connection process illustrated in FIG. 15 is a process of referring to circumjacent-terminal lists received from the distribution terminals 2B to register terminal names and contents names of distribution terminals 2B, which are discovered through the device discovery process within a search period, in a discovered-terminal list, and establishing communicable connection with the distribution terminal 2B by referring to the discovered-terminal list.

In FIG. 15, the third discovery unit 31B of the CPU 16 starts the execution of the device discovery process to distribute a device discovery request in a broadcasting manner (S71). The third discovery unit 31B starts a timer for the search period in response to starting the execution of the device discovery process (S72).

The third discovery unit 31B determines whether or not a device discovery response to the device discovery request of the device discovery process is received (S73). A terminal name of a device which receives the device discovery request is stored in the device discovery response. When it is determined that a device discovery response is received (Yes in S73), the third discovery unit 31B determines whether or not the discovered device is a distribution terminal 2B (S74). When it is determined that the discovered device is a distribution terminal 2B (Yes in S74), the third discovery unit 31B extracts a terminal name and a contents name of the distribution terminal 2B (S75). At this time, the acquisition terminal 3B transmits a service discovery request to the discovered distribution terminal 2B and extracts a contents name of the distribution terminal 2B in a service discovery response to the service discovery request upon receiving the service discovery response. The third discovery unit 31B adds the extracted terminal name and contents name of the distribution terminal 2B to the discovered-terminal list to register the extracted terminal name and contents name in the discovered-terminal storage area 21A (S76).

The third discovery unit 31B registers the circumjacent-terminal list (aggregation list) contained in the service discovery response in the aggregation storage area 22 (S77) and determines whether or not the search period started at S72 elapses (S78). When it is determined that the search period elapses (Yes in S78), the third discovery unit 31B displays the contents names on the display unit 12 in a list format by referring to the discovered-terminal list (S79). As a result, a user of the acquisition terminal 3B may recognize the contents names of the distribution terminals 2B which are discovered through the device discovery process. The control unit 33 refers to the discovered-terminal list and requests the information communication unit 32 to perform a connection establishment process for a distribution terminal 2B in the discovered-terminal list (S80).

The control unit 33 receives an icon from the connected distribution terminal 2B via the information communication unit 32 (S81) and displays the received icon on an application (S82). The control unit 33 determines whether or not a distribution terminal 2B which is not yet connected exists within the discovered-terminal list (S83). When it is determined that no distribution terminal 2B which is not yet connected exists within the discovered-terminal list (No in S83), the control unit 33 determines whether or not a distribution terminal 2B which does not exist within the discovered-terminal list exists in the aggregation storage area 22 (S84).

When it is determined that a distribution terminal 2B which does not exist within the discovered-terminal list exists in the aggregation storage area 22 (Yes in S84), the control unit 33 proceeds to S71 in order to issue a device discovery request and a service discovery request for the distribution terminal 2B. When it is determined that no distribution terminal 2B which does not exist within the discovered-terminal list exists in the aggregation storage area 22 (No in S84), the control unit 33 ends the processing operations illustrated in FIG. 15. When it is determined that a distribution terminal 2B which is not yet connected exists within the discovered-terminal list (Yes in S83), control unit 33 proceeds to S80 in order to request the information communication unit 32 to perform the connection establishment process for a not-yet-connected distribution terminal 2B.

When it is determined that a device discovery response is not received (No in S73) or when it is determined that the discovered device is not a distribution terminal 2B (No in S74), the third discovery unit 31B proceeds to S78 in order to determine whether or not the search period elapses. When it is determined that the search period does not elapse (No in S78), the third discovery unit 31B proceeds to S73 in order to determine whether or not a device discovery response is received.

Upon receiving the device discovery response to the device discovery request within the search period, the acquisition terminal 3B which performs the third connection process registers, in the discovered-terminal list, a terminal name and a contents name of a distribution terminal 2B which is discovered through the device discovery process. In addition, the acquisition terminal 3B displays the contents names contained in the discovered-terminal list on the display unit 12 in a list format. As a result, a user of the acquisition terminal 3B may recognize contents which may be offered by circumjacent distribution terminals 2B, by referring to the content name list.

After a lapse of the search period, the acquisition terminal 3B establishes a communicable connection with the respective discovered distribution terminals 2B by referring to the discovered-terminal list to acquire an icon from the respective distribution terminals 2B. As a result, since the acquisition terminal 3B may avoid the competition between the device discovery process and the connection establishment process owing to the search period, the icon may be quickly acquired from the distribution terminals 2B. Further, a user of the acquisition terminal 3B may reduce the time taken from the acquisition to the display of the icons of the distribution terminals 2B.

After performing the connection establishment process for all distribution terminals 2B in the discovered-terminal list, the acquisition terminal 3B transmits a device discovery request to a distribution terminal 2B which does not exist in the discovered-terminal list and exists in the aggregation storage area 22. As a result, a user of the acquisition terminal 3B may discover a distribution terminal 2B which is not discovered by using the device discovery function.

The distribution terminal 2B according to the third embodiment discovers, in advance, other distribution terminals 2B in a near-field radio communication range through a device discovery process and registers a circumjacent-terminal list of the other distribution terminals 2B in the circumjacent-terminal storage area 44. In addition, upon receiving a service discovery request from the acquisition terminal 3B, the distribution terminal 2B stores the circumjacent-terminal list in a service discovery response to the service discovery request and transmits the service discovery response to the acquisition terminal 3B. The acquisition terminal 3B registers a terminal name of the distribution terminal 2B in the discovered-terminal storage area 21A on the basis of the device discovery response and registers the circumjacent-terminal list in the aggregation storage area 22 on the basis of the service discovery response. The acquisition terminal 3B may acquire contents of circumjacent distribution terminals 2B without omission by referring to the discovered-terminal list and the aggregation list. As a result, since the acquisition terminal 3B may avoid the competition of the device discovery process and the connection establishment process between the acquisition terminal 3B and the distribution terminals 2B, the acquisition terminal 3B may quickly acquire the contents from the distribution terminals 2B. Therefore, a user of the acquisition terminal 3B may reduce the time taken from the acquisition to the display of the contents of the distribution terminals 2B.

Although, in the above-described embodiments, the WiFi Direct function has been described as an example of the near-field radio communication function, the present disclosure is not limited to the WiFi Direct function and may be applied to a system with the function of connection to a discovery device discovered by using the device discovery function.

Although the acquisition terminals 3A and 3B according to the second and third embodiments display the contents names of the distribution terminals 2A and 2B registered in the discovered-terminal storage area 21A on the display unit 12 in a list format, their terminal names, category names, or the like may be displayed, instead of the contents names.

Although the acquisition terminals 3, 3A, and 3B according to the first to third embodiments acquire icons from the distribution terminals 2, 2A, and 2B discovered by using the device discovery function, information such as contents may also be acquired without being limited to the icons.

The search period of the first to third embodiments may be adjusted by, for example, the acquisition terminals 3, 3A, and 3B, the distribution terminals 2, 2A, and 2B, or a management device managing these terminals. By setting a shorter search period, the processing time of the device discovery function for the discovery of the distribution terminals 2, 2A, and 2B may be reduced.

A variety of processing functions performed by the respective devices may be entirely or partially implemented by a CPU, a digital signal processor (DSP), a field programmable gate array (FPGA), or the like. The variety of processing functions may be entirely or partially implemented by a program interpreted and executed by a CPU or the like, or by hardware (wired logic).

Areas storing a variety of information may be configured with, for example, a ROM or a RAM such as a synchronous dynamic random access memory (SDRAM), a magneto-resistive random access memory (MRAM), or a non-volatile random access memory (NVRAM).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device, comprising:
a memory; and
a processor coupled to the memory and the processor configured to:
transmit a first request to discover devices through radio communication;
discover first devices on basis of first responses to the first request within a predetermined period, the first responses being received from the respective first devices;
establish, after a lapse of the predetermined period, a connection with the respective first devices; and
acquire information from the respective first devices.

2. The communication device according to claim 1, wherein the processor is configured to:
acquire meta information from the respective first devices, the meta information being information relating to the respective first devices; and
display the acquired meta information of the respective first devices.

3. The communication device according to claim 1, wherein the processor is configured to:
adjust the predetermined period.

4. The communication device according to claim 1, wherein the processor is configured to:
acquire a circumjacent-device list from the respective first devices;
transmit a second request to discover devices listed in the circumjacent-device list through radio communication; and
discover second devices on basis of second responses to the second request, the second responses being received from the respective second devices.

5. An information acquisition system, comprising:
a plurality of distribution devices each including:
a first memory, and
a first processor coupled to the first memory; and
a communication device including:
a second memory, and
a second processor coupled to the second memory and the second processor configured to:
transmit a first request to discover distribution devices among the plurality of distribution devices through radio communication;
discover first distribution devices on basis of first responses to the first request within a predetermined period, the first responses being received from the respective first distribution devices;
establish, after a lapse of the predetermined period, a connection with the respective first distribution devices; and
acquire information from the respective first distribution devices.

6. The information acquisition system according to claim 5, wherein the first processor is configured to:
transmit a second request to discover other distribution devices among the plurality of distribution devices through radio communication;
discover second distribution devices on basis of second responses to the second request, the second responses being received from the respective second distribution devices; and
generate a circumjacent-device list including information regarding the respective second distribution devices, and the second processor is configured to:
acquire the circumjacent-device list from the respective first distribution devices;
transmit a third request to discover distribution devices listed in the circumjacent-device list through radio communication; and
discover third distribution devices on basis of third responses to the third request, the third responses being received from the respective third distribution devices.

7. A non-transitory computer-readable recording medium having stored therein a program that causes a computer to execute a process, the process comprising:
transmitting a first request to discover devices through radio communication;
discovering first devices on basis of first responses to the first request within a predetermined period, the first responses being received from the respective first devices;
establishing, after a lapse of the predetermined period, a connection with the respective first devices; and
acquiring information from the respective first devices.
